(19) United States
(12) Patent Application Publication
(10) Pub. No.: US 2026/0155312 A1
(43) Pub. Date: Jun. 4, 2026

(54) MULTILAYER CERAMIC CAPACITOR

(71) Applicant: Murata Manufacturing Co., Ltd., Nagaokakyo-shi (JP)

(72) Inventor: Kazuhiro NISHIBAYASHI, Nagaokakyo-shi (JP)

(21) Appl. No.: 19/457,684

(22) Filed: Jan. 23, 2026

Related U.S. Application Data
(63) Continuation of application No. PCT/JP2024/023951, filed on Jul. 2, 2024.

(30) Foreign Application Priority Data
Aug. 2, 2023 (JP) 2023-126525

(51) Int. Cl. H01G 4/30; H01G 4/12; H01G 4/232

(52) U.S. Cl. CPC H01G 4/30; H01G 4/1245; H01G 4/2325

(57) ABSTRACT

A three-terminal laminated ceramic capacitor includes a laminate including an inner layer section including dielectric layers and internal electrodes alternatingly laminated, a first outer layer portion on one side of the inner layer section, and a second outer layer portion on the other side thereof, end-surface external electrodes on both end surfaces of the laminate in a lengthwise direction, and lateral-surface external electrodes on the lateral surfaces of the laminate in a widthwise direction. A dimension LC in the lengthwise direction satisfies 0.1 mm≤LC≤0.70 mm or less, a dimension WC in the widthwise direction satisfies 0.05 mm≤WC≤0.40 mm or less, a dimension TC in a lamination direction satisfies 0.10 mm≤TC≤0.55 mm or less. The second outer layer portion is on the mounting surface side, and t1<t2 when a thickness of the first outer layer portion is t1 and a thickness of the second outer layer portion is t2.

### CROSS REFERENCE TO RELATED APPLICATIONS

This application claims the benefit of priority to Japanese Patent Application No. 2023-126525 filed on Aug. 2, 2023 and is a Continuation Application of PCT Application No. PCT/JP 2024/023951 filed on Jul. 2, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

Recently, low impedance of electronic circuit lines has become important, particularly for mobile device products. For lowering impedance of electronic circuit lines, three-terminal multilayer ceramic capacitors for decoupling applications are widely used. A three-terminal multilayer ceramic capacitor includes a multilayer body including an inner layer portion in which dielectric layers having end surface internal electrodes exposed at end surfaces and dielectric layers having lateral surface internal electrodes exposed at lateral surfaces are alternately laminated in multiple layers, and outer layer portions provided on one side and the other side of the inner layer portion in the lamination direction, end surface external electrodes provided on the end surfaces, and lateral surface external electrodes provided on the lateral surfaces (see Japanese Unexamined Patent Application Publication No. 2013-201417).

A three-terminal multilayer ceramic capacitor can achieve lower impedance in high-frequency characteristics by reducing in size. The lower impedance achieved by size reduction is derived from a reduction in equivalent series inductance (ESL) of the multilayer ceramic capacitor.

### SUMMARY OF THE INVENTION

Here, in a multilayer ceramic capacitor, external electrodes each extend not only to lateral surfaces of the multilayer body but also to main surfaces where outer layer portions of the multilayer body are provided, such that wrap-around portions of the external electrodes are provided on the main surfaces of the multilayer body.

Also, when a multilayer ceramic capacitor is mounted on a substrate with solder, the mounting-side surface is susceptible to the effects of deflection when the substrate deflects, and stress particularly concentrates at the tips of the wrap-around portions.

As multilayer ceramic capacitors become smaller, the outer layer portions also become thinner, making cracks more likely to occur from the tips of the wrap-around portions toward the interior of the outer layer portions, and there is a possibility that cracks may reach the counter portions of internal electrodes that function as capacitors.

Example embodiments of the present invention provide small three-terminal multilayer ceramic capacitors for which less cracks in each reach counter portions of internal electrodes that function as capacitors.

An example embodiment of the present invention provides a three-terminal multilayer ceramic capacitor which includes a multilayer body including an inner layer portion in which a plurality of dielectric layers and a plurality of internal electrodes are alternately laminated, and a first outer layer portion on one side of the inner layer portion in a lamination direction and a second outer layer portion on the other side of the inner layer portion in the lamination direction, end surface external electrodes each provided on one of both end surfaces of the multilayer body in a length direction intersecting the lamination direction, and a lateral surface external electrode provided on at least one of lateral surfaces of the multilayer body in a width direction intersecting the lamination direction and the length direction. The multilayer ceramic capacitor includes a dimension LC in the length direction of about 0.1 mm≤LC≤about 0.70 mm or less, a dimension WC in the width direction of about 0.05 mm≤WC≤about 0.40 mm or less, and a dimension TC in the lamination direction of about 0.10 mm ≤TC ≤about 0.55 mm or less, the second outer layer portion is located on a mounting surface side, and when a thickness of the first outer layer portion is defined as t1 and a thickness of the second outer layer portion is defined as t2, t1<t2 is satisfied.

According to example embodiments of the present invention, small three-terminal multilayer ceramic capacitors for which less cracks in each reach counter portions of internal electrodes that function as capacitors are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view of a multilayer ceramic capacitor 1.

FIG. 2 is a cross-sectional view of the multilayer ceramic capacitor 1 taken along the II-II direction in FIG. 1 according to a first example embodiment of the present invention.

FIG. 3 is a cross-sectional view of the multilayer ceramic capacitor 1 taken along the III-III direction in FIG. 1 according to a first example embodiment of the present invention.

FIG. 4 is a cross-sectional view of the multilayer ceramic capacitor 1 along an end surface exposed internal electrode 15A.

FIG. 5 is a cross-sectional view of the multilayer ceramic capacitor 1 along a lateral surface exposed internal electrode 15B.

FIG. 6 is a diagram for explaining a manufacturing process of a multilayer body 2 in a method of manufacturing the multilayer ceramic capacitor 1.

FIG. 7 is a flowchart for explaining a method of manufacturing the multilayer ceramic capacitor 1.

### DETAILED DESCRIPTION OF THE EXAMPLE EMBODIMENTS

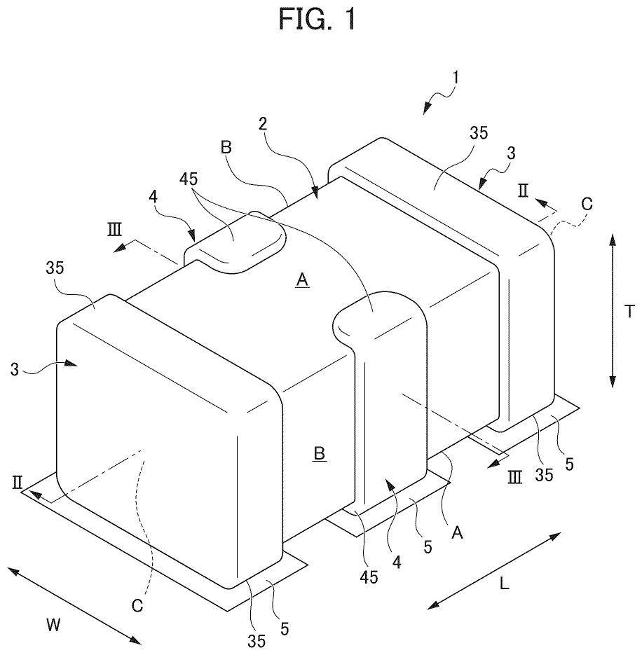

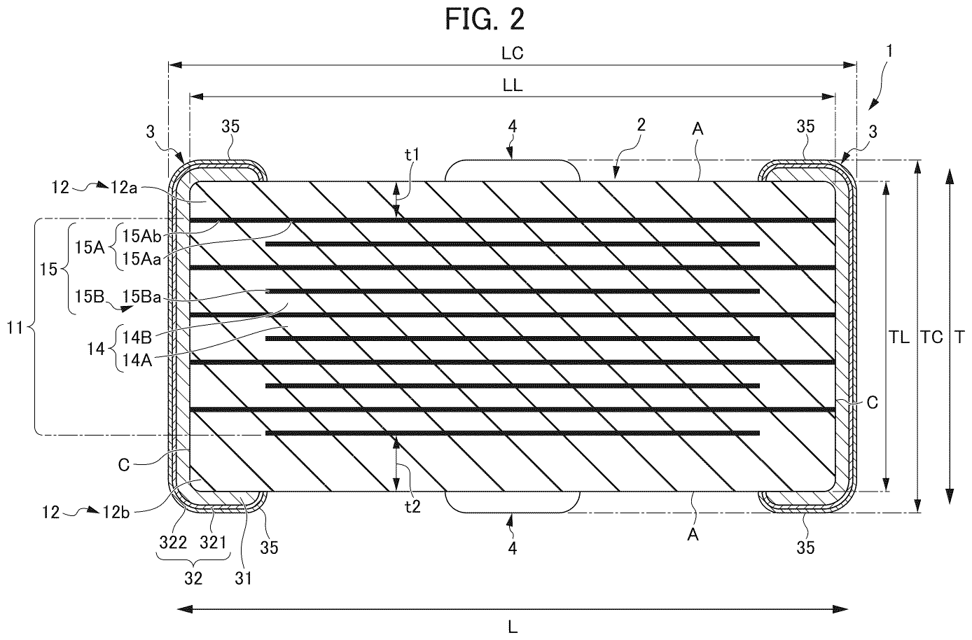

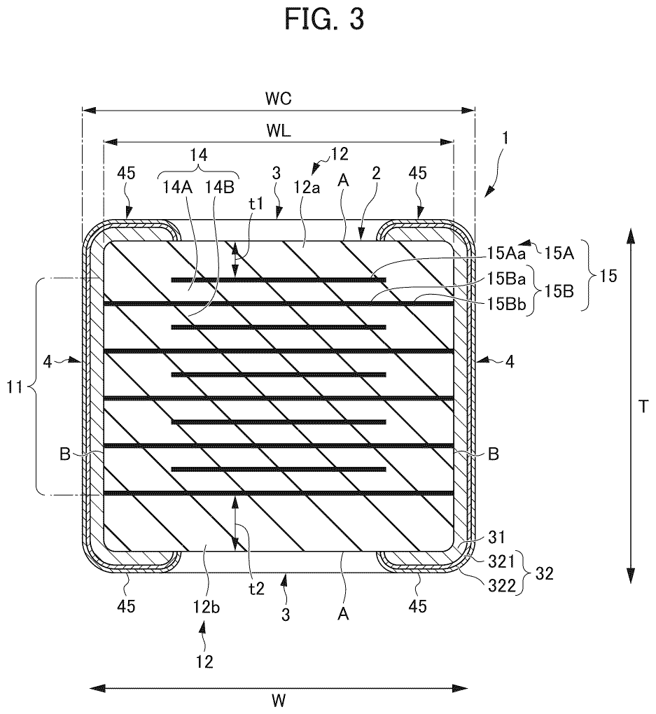

Hereinafter, multilayer ceramic capacitor according to example embodiments of the present invention will be described. FIG. 1 is a schematic perspective view of a multilayer ceramic capacitor 1. FIG. 2 is a cross-sectional view of the multilayer ceramic capacitor 1 taken along the II-II direction in FIG. 1 according to a first example embodiment. FIG. 3 is a cross-sectional view of the multilayer ceramic capacitor 1 taken along the III-III direction in FIG. 1 according to a first example embodiment.

The multilayer ceramic capacitor 1 is a three-terminal multilayer ceramic capacitor 1 which includes a multilayer body 2, end surface external electrodes 3 provided on both end surfaces C in the length direction L of the multilayer body 2, and lateral surface external electrodes 4 provided on both lateral surfaces B in the width direction W of the multilayer body 2. The multilayer body 2 includes an inner layer portion 11 in which dielectric layers 14 and internal electrodes 15 are laminated, and outer layer portions 12.

In the present specification, as terms representing the orientation of the multilayer ceramic capacitor 1, the direction in which the dielectric layers 14 and the internal electrodes 15 are laminated in the multilayer ceramic capacitor 1 is defined as the lamination direction T. The direction intersecting the lamination direction T and in which the pair of end surface external electrodes 3 are provided is defined as the length direction L. The direction intersecting both the length direction L and the lamination direction T is defined as the width direction W. In the example embodiments, the lamination direction T, the length direction L, and the width direction W are orthogonal to each other.

In the following description, among the six outer surfaces of the multilayer body 2, a pair of outer surfaces provided on both sides in the lamination direction T are defined as main surfaces A, a pair of outer surfaces extending in the lamination direction T and provided on both sides in the width direction W are defined as lateral surfaces B, and a pair of outer surfaces extending in the lamination direction T and provided on both sides in the length direction L are defined as end surfaces C.

The multilayer ceramic capacitor 1 shown in FIG. 2 or FIG. 3 has a length direction dimension LC of about 0.1 mm or more and about 0.70 mm or less, a width direction dimension WC of about 0.05 mm or more and about 0.40 mm or less, and a lamination direction dimension TC of about 0.10 mm or more and about 0.55 mm or less, for example.

Furthermore, the capacitance of the multilayer ceramic capacitor 1 is about 0.022 μF or more and about 10 μF or less, and preferably about 1.0 μF or more and about 2.2 μF or less, for example. The ESL of the multilayer ceramic capacitor 1 is about 65 pH or less at about 100 MHz, and preferably about 50 pH or less at about 1 GHz, for example.

The capacitance of the multilayer ceramic capacitor 1 can be obtained using an LCR meter (available from Agilent Technologies, model number: E4980A) under conditions of 1 kHz and 0.5 Vrms. The ESL of the multilayer ceramic capacitor 1 can be obtained by calculation from measured impedance values at predetermined frequencies using a network analyzer (available from Agilent Technologies, model number: E5080A).

The multilayer body 2 includes an inner layer portion 11 and outer layer portions 12 provided on both sides of the inner layer portion 11 in the lamination direction T. It is preferable that the multilayer body 2 includes rounded corner portions and ridge portions. The corner portions are portions where three surfaces of the multilayer body 2 intersect, and the ridge portions are portions where two surfaces of the multilayer body 2 intersect.

The dimensions of the multilayer body 2, as shown in FIG. 2 or FIG. 3, are such that the dimension LL in the length direction L is about 0.09 mm or more and about 0.69 mm or less, the dimension WL in the width direction W is about 0.04 mm or more and about 0.39 mm or less, and the dimension TL in the lamination direction T is about 0.09 mm or more and about 0.54 mm or less, for example.

The inner layer portion 11 includes a plurality of dielectric layers 14 and internal electrodes 15 laminated along the lamination direction T.

The dielectric layers 14 are each made of ceramic material. As the ceramic material, a ceramic material including as a main component at least one of Ca, Zr, or Ti is used. Specifically, for example, a ceramic material having a perovskite structure represented by a general formula ABO₃ including Ca and Zr is used as the main component. Examples of such ceramic materials having a perovskite structure include, but are not limited to, BaTiO₃ (barium titanate) and CaZrO₃ (calcium zirconate). Further, the main component of the ceramic material forming the dielectric layers 14 may include all of Ca, Zr, and Ti.

The internal electrodes 15 are each preferably made of a metal material such as Ni, Cu, Ag, Pd, Ag—Pd alloy, Au, or the like.

The internal electrodes 15 include a plurality of end surface-exposed internal electrodes 15A and a plurality of lateral surface-exposed internal electrodes 15B that are alternately provided. When it is not necessary to distinguish between the end surface-exposed internal electrodes 15A and the lateral surface-exposed internal electrodes 15B, they are collectively described as internal electrodes 15.

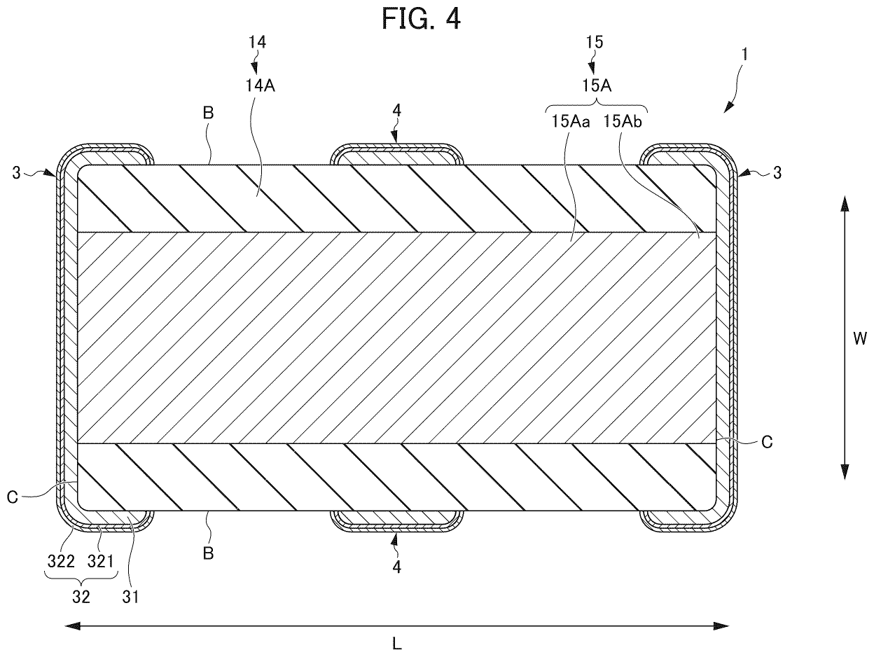

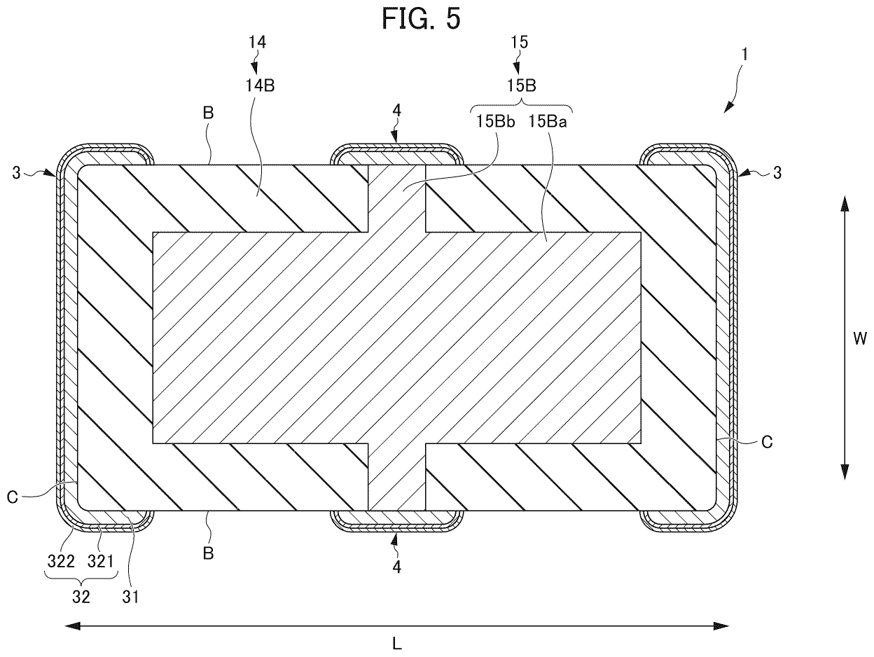

FIG. 4 is a cross-sectional view taken along the end surface-exposed internal electrode 15A of the multilayer ceramic capacitor 1. FIG. 5 is a cross-sectional view taken along the lateral surface-exposed internal electrode 15B of the multilayer ceramic capacitor 1.

As shown in FIG. 4, the end surface exposed internal electrode 15A extends between both end surfaces C in the length direction L of the multilayer body 2 and is spaced apart from both lateral surfaces B in the width direction W by a fixed distance. The end surface exposed internal electrode 15A includes an end surface counter portion 15Aa located in the middle portion between both end surfaces C, and end surface extension portions 15Ab extending from the end surface counter portion 15Aa toward both end surfaces C. In the example embodiments, the end surface counter portion 15Aa and the end surface extension portions 15Ab have equal or substantially equal dimensions in the width direction W, and the end surface exposed internal electrode 15A is rectangular or substantially rectangular as a whole including the end surface counter portion 15Aa and the end surface extension portions 15Ab. The end surface extension portions 15Ab extending from the end surface counter portion 15Aa toward both end surfaces C extend toward both end surfaces C respectively and are exposed at the end surfaces C of the multilayer body 2, and are connected to the end surface external electrodes 3 provided on both end surfaces C in the length direction L of the multilayer body 2.

As shown in FIG. 5, the lateral surface exposed internal electrode 15B includes a lateral surface counter portion 15Ba located in the middle between both lateral surfaces B, and lateral surface extension portions 15Bb each extending from the lateral surface counter portion 15Ba toward both lateral surfaces B. The lateral surface counter portion 15Ba has a substantially rectangular shape that is slightly smaller than the multilayer body 2, and is spaced apart from both end surfaces B in the width direction W by a fixed distance.

The dimension of each of the lateral surface extension portions 15Bb in the length direction L is smaller than the dimension of the lateral surface counter portion 15Ba in the length direction L. The lateral surface extension portions 15Bb each extend toward both lateral surfaces B and are exposed at the lateral surfaces B of the multilayer body 2, and are each connected to the lateral surface external electrodes 4 provided on both lateral surfaces of the multilayer body 2 in the width direction W.

The end surface counter portion 15Aa and the lateral surface counter portion 15Ba are opposed to each other to define a capacitor portion.

The dielectric layers 14 include first dielectric layers 14A on which the end surface exposed internal electrodes 15A exposed at the end surfaces C are provided, and second dielectric layers 14B on which the lateral surface exposed internal electrodes 15B exposed at portions of the lateral surfaces B are provided, and the first dielectric layers 14A and the second dielectric layers 14B are alternately laminated.

With reference to FIG. 2 and FIG. 3 again, each of the outer layer portions 12 is a dielectric layer provided adjacent to a corresponding one of the main surfaces A of the inner layer portion 11. Each of the outer layer portions 12 is made of the same material as the dielectric layer 14 of the inner layer portion 11. The outer layer portions 12 include a first outer layer portion 12a provided adjacent to the first main surface A of the inner layer portion 11, and a second outer layer portion 12b provided adjacent to the second main surface A of the inner layer portion 11. When it is not necessary to distinguish between the first outer layer portion 12a and the second outer layer portion 12b, they are collectively described as the outer layer portion 12.

In the present example embodiment, the first outer layer portion 12a and the second outer layer portion 12b have different thicknesses from each other, and when the thickness of the first outer layer portion 12a is defined as t1 and the thickness of the second outer layer portion 12b is defined as t2, t1<t2 is satisfied. Here, when the multilayer ceramic capacitor 1 is mounted on the land 5 of the mounting substrate, the second outer layer portion 12b corresponds to the mounting surface.

Further, in the present example embodiment, about 10 μm≤t1≤about 30 μm, and about 0.1≤t1/t2 ≤about 0.9 are satisfied.

The end surface external electrodes 3 are provided on both end surfaces C of the multilayer body 2. The end surface extension portions 15Ab of the end surface exposed internal electrodes 15A are connected to the end surface external electrodes 3. The end surface external electrodes 3 each cover not only a corresponding one of the end surfaces C, but also a portion of each of the main surfaces A and a portion of each of the lateral surfaces B adjacent to the end surfaces C. The end surface external electrodes 3 each include a wrap-around portion which covers the portion of the main surfaces A and the portion of the lateral surfaces B adjacent to the end surfaces C.

The lateral surface external electrodes 4 are each provided on a corresponding one of both lateral surfaces B of the multilayer body 2. The lateral surface extension portions 15Bb of the lateral surface exposed internal electrodes 15B are connected to the lateral surface external electrodes 4. The lateral surface external electrodes 4 each cover not only a corresponding one of the lateral surfaces B, but also a portion of each of the main surfaces A adjacent to the lateral surfaces B.

Each of the end surface external electrodes 3 and each of the lateral surface external electrodes 4 respectively include a base electrode layer 31 and a plated layer 32 provided on the base electrode layer 31. The plated layer 32 includes a Ni (nickel) plated layer 321 provided on the base electrode layer 31 and a Sn (tin) plated layer 322 provided on the Ni plated layer 321. However, example embodiments of the present invention are not limited to such configurations and, for example, the end surface external electrodes 3 and the lateral surface external electrodes 4 each may include a configuration in which, for example, the base electrode layer 31 is made of Ni, and a Cu plated layer, a Ni plated layer, and a Sn plated layer are provided in this order thereon.

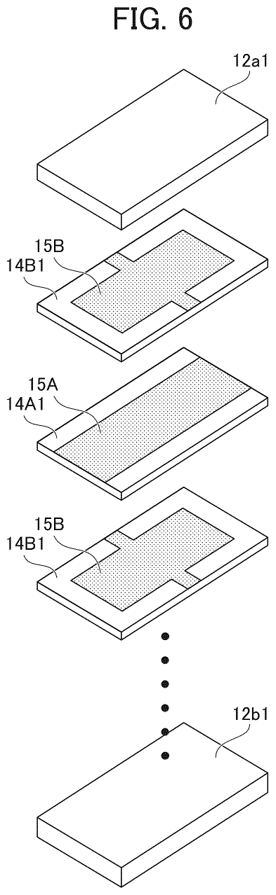

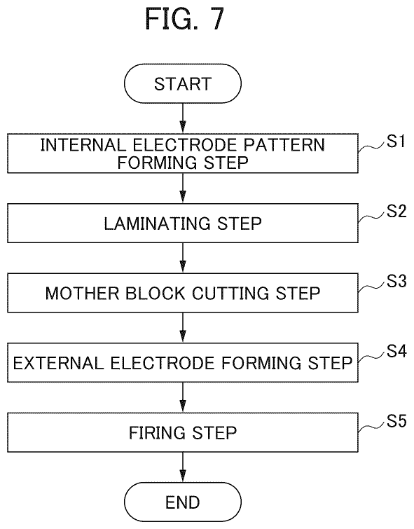

Next, a non-limiting example of a method of manufacturing the multilayer ceramic capacitor 1 of the present example embodiment will be described. FIG. 6 is a diagram for explaining the manufacturing steps of the multilayer body 2 in the method of manufacturing the multilayer ceramic capacitor 1. FIG. 7 is a flowchart for explaining the method of manufacturing the multilayer ceramic capacitor 1.

The end surface exposed internal electrodes 15A are formed on ceramic green sheets 14A1 functioning as the first dielectric layers 14A using an electrically conductive paste. Similarly, the lateral surface exposed internal electrodes 15B are formed on ceramic green sheets 14B1 functioning as the second dielectric layers 14B using an electrically conductive paste.

The ceramic green sheets 14A1 and the ceramic green sheets 14B1 are strip-shaped sheets formed by molding a ceramic slurry containing ceramic powder, binder, and solvent into a sheet shape on a carrier film using a die coater, gravure coater, microgravure coater, or the like.

The end surface exposed internal electrodes 15A and the lateral surface exposed internal electrodes 15B are formed by, for example, printing such as screen printing, gravure printing, or relief printing.

The ceramic green sheets 14A1 that function as the first dielectric layers 14A on which the end surface exposed internal electrodes 15A are provided and the ceramic green sheets 14B1 that function as the second dielectric layers 14B on which the lateral surface exposed internal electrodes 15B are provided are alternately laminated.

Subsequently, the ceramic green sheets 12a1 for manufacturing the first outer layer portion 12a and the ceramic green sheets 12b1 for manufacturing the second outer layer portion 12b are provided on the upper and lower sides, and thermocompression bonded to form a mother block.

At this time, in the present example embodiment, the ceramic green sheet 12a1 for manufacturing the first outer layer portion 12a and the ceramic green sheet 12b1 for manufacturing the second outer layer portion 12b have different thicknesses. The ceramic green sheet 12a1 for manufacturing the first outer layer portion 12a has a thickness of t1 after firing, and the ceramic green sheet 12b1 for manufacturing the second outer layer portion 12b is made of the same material as the ceramic green sheet 12a1 for manufacturing the first outer layer portion 12a but has a different thickness, and has a thickness that results in t2, which is thicker than t1, after firing. Here, t1 is a thickness satisfying about 10 μm≤t1≤about 30 μm and about 0.1≤t1/t2≤about 0.9, for example.

However, example embodiments of the present invention are not limited thereto, and it is possible to use the ceramic green sheet 12b1 for manufacturing the second outer layer portion 12b that has a higher inorganic component ratio than the ceramic green sheet 12a1 for manufacturing the first outer layer portion 12a. In this case, even when the ceramic green sheet 12a1 for manufacturing the first outer layer portion 12a and the ceramic green sheet 12b1 for manufacturing the second outer layer portion 12b have the same thickness, since the shrinkage ratio of the second outer layer portion 12b during firing is smaller, it is possible to make the second outer layer portion 12b thicker than the first outer layer portion 12a after firing.

As another method, it is possible to use the ceramic green sheet 12b1 for manufacturing the second outer layer portion 12b made of the same material and having the same thickness as the ceramic green sheet 12a1 for manufacturing the first outer layer portion 12a, provide an additional firing step before forming the external electrodes, and polish the first outer layer portion 12a after firing to make the first outer layer portion 12a thinner than the second outer layer portion 12b.

Next, the mother block is cut and divided in the length direction L and the width direction W to manufacture a plurality of rectangular or substantially rectangular parallelepiped multilayer bodies 2.

Next, the lateral surface external electrodes 4 are formed on both lateral surfaces B of the multilayer body 2. The lateral surface extension portions 15Bb of the lateral surface exposed internal electrodes 15B are connected to the lateral surface external electrodes 4. The lateral surface external electrodes 4 are formed to cover not only the lateral surfaces B, but also portions of the main surfaces A adjacent to the lateral surfaces B.

Then, the end surface external electrodes 3 are formed on both end surfaces C of the multilayer body 2. The end surface extension portions 15Ab of the end surface exposed internal electrodes 15A are connected to the end surface external electrodes 3. The end surface external electrodes 3 are formed to cover not only the end surfaces C, but also portions of the main surfaces A and portions of lateral surfaces B adjacent to the end surfaces C.

Then, heating is performed for a predetermined period of time in a nitrogen atmosphere at a set firing temperature. Thus, the end surface external electrodes 3 and the lateral surface external electrodes 4 are fired on the multilayer body 2 to manufacture the multilayer ceramic capacitor 1 shown in FIG. 1.

The multilayer ceramic capacitors 1 manufactured in this manner are accommodated one by one in each of a plurality of storage recesses provided in a carrier tape upon conveying. The opening of each of the storage portions is covered with a top tape, and the multilayer ceramic capacitors 1 are conveyed in the form of a packaging tape.

When accommodating the multilayer ceramic capacitors 1 in the storage recesses of the carrier tape, it is preferred that all the multilayer ceramic capacitors 1 are accommodated such that they have the same orientation. Therefore, for example, during accommodation, the multilayer ceramic capacitors 1 are placed in a magnetic field. In this case, the magnetic flux amount differs between the first outer layer portion 12a and the second outer layer portion 12b. By sorting the orientation of each of the multilayer ceramic capacitors 1 in the lamination direction T based on this difference in magnetic flux amount, it is possible to accommodate the multilayer ceramic capacitors 1 in the storage portions in a fixed orientation.

Alternatively, since the first outer layer portion 12a and the second outer layer portion 12b have different thicknesses, the color shading may differ. It is also possible to sort the orientations of the multilayer ceramic capacitors 1 in the lamination direction T based on this difference in shading.

Furthermore, to indicate that the second outer layer portion 12b, which is thicker than the first outer layer portion 12a, is the mounting surface, for example, the letter “m” may be printed on the main surface A adjacent to the second outer layer portion 12b to indicate that it is the mount side.

In addition, since the second outer layer portion 12b, which is the mounting surface, is thicker than the first outer layer portion 12a, the corner portions are more rounded than those of the first outer layer portion 12a. Therefore, the second outer layer portion 12b, which is the mounting surface, may be identified by this difference in roundness of the corner portions.

The multilayer ceramic capacitor 1 is mounted on a substrate as follows, for example. First, the top tape is peeled off while moving the carrier tape in one direction. In this state, the multilayer ceramic capacitor 1 in the storage recess of the carrier tape is taken out by a mounter nozzle and mounted via solder on a land 5 (shown in FIG. 1) made of an electrically conductive material on the surface of the substrate. At this time, the second outer layer portion 12b functions as the mounting surface to the substrate.

Here, in the example embodiments, when the thickness of the first outer layer portion 12a is defined as t1, about 10 μm≤t1≤about 30 μm is satisfied, for example. When the thickness of the first outer layer portion 12a is t1<about 10 μm, for example, the multilayer ceramic capacitor 1 may be damaged by shock during placement on the land 5 by the mounter nozzle. However, in the example embodiments, since about 10 μm≤t1 is satisfied, for example, the multilayer ceramic capacitor 1 is less likely to be damaged by this shock. Further, when the thickness of the first outer layer portion 12a is about 30 μm<t1, in the multilayer body 2 having a dimension TL in the lamination direction T of about 0.54 mm or less, for example, the first outer layer portion 12a becomes thick and the inner layer portion 11 becomes relatively thin. This is not preferred because the capacitance of the multilayer ceramic capacitor 1 becomes small. However, in the example embodiment, since t1≤about 30 μm is satisfied, for example, it is possible to sufficiently secure the thickness of the inner layer portion 11.

In the multilayer ceramic capacitor 1, each of the end surface external electrodes 3 extends not only on the end surface C of the multilayer body 2, but also to the main surfaces A and lateral surfaces B where the outer layer portion 12 of the multilayer body 2 is provided, and the wrap-around portions 35 of the end surface external electrode 3 are provided on the main surfaces A of the multilayer body 2. Further, in the multilayer ceramic capacitor 1, each of the lateral surface external electrodes 4 extends not only on the lateral surface B of the multilayer body 2, but also to the main surfaces A where the outer layer portion 12 of the multilayer body 2 is provided, and the wrap-around portions 45 of each of the lateral surface external electrodes 4 are provided on the main surfaces A of the multilayer body 2.

When the multilayer ceramic capacitor 1 is mounted on a substrate via solder, the main surface A on the mounting side is likely to be affected by deflection when the substrate deflects, and stress is likely to concentrate particularly at the tips of the wrap-around portion 35 and the wrap-around portion 45 on the main surface A on the mounting side.

As the multilayer ceramic capacitor 1 is reduced in size, the outer layer portion 2 also becomes thinner, so cracks are likely to occur from the tips of the wrap-around portion 35 and the wrap-around portion 45 toward the inside of the outer layer portion 2, and the cracks may reach the end surface counter portion 15Aa of the end surface exposed internal electrode 15A, the lateral surface exposed internal electrode 15B, or the lateral surface counter portion 15Ba functioning as a capacitor.

However, in the present example embodiment, the first outer layer portion 12a and the second outer layer portion 12b have different thicknesses, and when the thickness of the first outer layer portion 12a is defined as t1 and the thickness of the second outer layer portion 12b is defined as t2, t1<t2 is satisfied. Therefore, even in such a small three-terminal multilayer ceramic capacitor 1 as in example embodiments of the present application, it is possible to reduce cracks reaching the counter portions (the end surface counter portion 15Aa or the lateral surface counter portion 15Ba) of the internal electrode 15 that functions as a capacitor.

Further, since the dielectric layer 14 of the multilayer ceramic capacitor 1 has piezoelectricity and electrostriction, stress and mechanical strain occur when an electric field is applied. Such stress and mechanical strain are transmitted as vibrations to the substrate on which the multilayer ceramic capacitor 1 is mounted. As a result, the entire substrate functions as an acoustic reflection surface, and so-called “acoustic noise” occurs, which is vibration sound that becomes noise. As the multilayer ceramic capacitor 1 is reduced in size, the outer layer portion also becomes thinner, so the “acoustic noise” is more likely to be transmitted to the substrate.

However, in the present example embodiment, the first outer layer portion 12a and the second outer layer portion 12b have different thicknesses, and when the thickness of the first outer layer portion 12a is defined as t1 and the thickness of the second outer layer portion 12b is defined as t2, t1<t2 is satisfied. That is, the thickness t2 of the second outer layer portion 12b, which is on the mounting side to the substrate, is greater than the thickness t1 of the first outer layer portion 12a. Therefore, even in such a small three-terminal multilayer ceramic capacitor 1 as in the present example embodiment, the “acoustic noise” is less likely to be transmitted to the substrate.

Furthermore, in the present example embodiment, a ratio of the thickness t1 of the first outer layer portion 12a to the thickness t2 of the second outer layer portion 12 b is about 0.1≤t1/t2≤about 0.9, for example.

Unlike the example embodiment, when t1/t2<about 0.1 is satisfied, for example, that is, when about 10×t1<t2 is satisfied, the second outer layer portion 12b is considerably thick with respect to the first outer layer portion 12a. When the second outer layer portion 12b is extremely thick, a path of current flowing from the substrate to the end surface exposed internal electrode 15A becomes long, and thus ESL of the multilayer ceramic capacitor 1 becomes large.

Further, unlike the example embodiment, when about 0.9<t1/t2 is satisfied, that is, when about 0.9×t2<t1 is satisfied, for example, the thicknesses of the first outer layer portion 12a and the second outer layer portion 12b do not differ from each other very much. In this case, it is not possible to sufficiently obtain the above-described advantageous effect of preventing “acoustic noise”.

However, according to the present example embodiment, since about 0.1≤t1/t2≤about 0.9, for example, it is possible to sufficiently obtain the advantageous effect of preventing “acoustic noise” without increasing ESL of the multilayer ceramic capacitor 1.

Although example embodiments of the present invention have been described above, the present invention is not limited to the above-described example embodiments, and various changes and modifications are possible.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A three-terminal multilayer ceramic capacitor comprising:
a multilayer body including an inner layer portion in which a plurality of dielectric layers and a plurality of internal electrodes are alternately laminated in a lamination direction, and a first outer layer portion on one side of the inner layer portion in the lamination direction and a second outer layer portion on the other side of the inner layer portion in the lamination direction;
end surface external electrodes each provided on one of both end surfaces of the multilayer body in a length direction intersecting the lamination direction; and
a lateral surface external electrode provided on at least one of lateral surfaces of the multilayer body in a width direction intersecting the lamination direction and the length direction; wherein
a dimension LC in the length direction is about 0.1 mm≤LC≤about 0.70 mm or less;
a dimension WC in the width direction is about 0.05 mm≤WC≤about 0.40 mm or less; and
a dimension TC in the lamination direction is about 0.10 mm≤TC≤about 0.55 mm or less;
the second outer layer portion is located on a mounting surface side; and
when a thickness of the first outer layer portion is defined as t1 and a thickness of the second outer layer portion is defined as t2, t1<t2 is satisfied.

2. The multilayer ceramic capacitor according to claim 1, wherein about 10 μm≤t1≤about 30 μm and about 0.1≤t1/t2≤about 0.9 are satisfied.

3. The multilayer ceramic capacitor according to claim 1, wherein a capacitance is about 0.022 μF or more and about 10 μF or less.

4. The multilayer ceramic capacitor according to claim 1, wherein an equivalent series inductance is about 65 pH or less at about 100 MHz and about 50 pH or less at about 1 GHz.

5. The multilayer ceramic capacitor according to claim 1, wherein a capacitance is about 1.0 μF or more and about 2.2 μF or less.

6. The multilayer ceramic capacitor according to claim 1, wherein the multilayer body includes rounded corner portions and ridge portions.

7. The multilayer ceramic capacitor according to claim 1, wherein the multilayer body includes dimensions of about 0.09 mm or more and about 0.69 mm or less in the length direction, about 0.04 mm or more and about 0.39 mm or less in the width direction, and about 0.09 mm or more and about 0.54 mm or less in the lamination direction.

8. The multilayer ceramic capacitor according to claim 1, wherein the plurality of dielectric layers include ceramic material.

9. The multilayer ceramic capacitor according to claim 8, wherein the ceramic material includes at least one of Ca, Zr, or Ti.

10. The multilayer ceramic capacitor according to claim 8, wherein the ceramic material has a perovskite structure including Ca and Zr.

11. The multilayer ceramic capacitor according to claim 8, wherein the ceramic material includes barium titanate and calcium zirconate.

12. The multilayer ceramic capacitor according to claim 8, wherein the ceramic material includes Ca, Zr, and Ti.

13. The multilayer ceramic capacitor according to claim 1, wherein the plurality of internal electrodes include Ni, Cu, Ag, Pd, an Ag-Pd alloy, or Au.

14. The multilayer ceramic capacitor according to claim 1, wherein each of the end surface external electrodes and the lateral surface external electrode includes a base electrode layer and a plated layer.

15. The multilayer ceramic capacitor according to claim 14, wherein the plated layer includes a Ni plated layer and a Sn plated layer.

16. The multilayer ceramic capacitor according to claim 1, wherein each of the end surface external electrodes and the lateral surface external electrode includes a base electrode layer made of Ni, a Cu plated layer, a Ni plated layer, and a Sn plated layer.

17. The multilayer ceramic capacitor according to claim 1, wherein each of the end surface external electrodes extends on the end surfaces of the multilayer body to main surfaces and the lateral surfaces of the multilayer body.

18. The multilayer ceramic capacitor according to claim 1, wherein each of the end surface external electrodes includes wrap-around portions extending to main surfaces of the multilayer body.

19. The multilayer ceramic capacitor according to claim 1, wherein the lateral surface external electrode extends from the one of the lateral surfaces to a main surface of the multilayer body.

20. The multilayer ceramic capacitor according to claim 1, wherein the lateral surface external electrode includes a wrap-around portion extending to one of main surface of the multilayer body.
